(19) United States
(12) Patent Application Publication
(10) Pub. No.: US 2016/0100100 A1
(43) Pub. Date: Apr. 7, 2016

(54) Method for Configuring Screen, Electronic Device and Storage Medium

(71) Applicant: Samsung Electronics Co., Ltd., Suwon-si (KR)

(72) Inventor: Jang-Heon RYU, Anyang-si (KR)

(21) Appl. No.: 14/850,687

(22) Filed: Sep. 10, 2015

(30) Foreign Application Priority Data
Oct. 1, 2014 (KR) 10-2014-0132207

(51) Int. Cl. H04N 5/232; G06T 1/00; G06F 3/0484; G06F 3/0481

(52) U.S. Cl. CPC H04N 5/23222; H04N 5/23293; G06F 3/04817; G06T 1/0007; G06F 3/04845

(57) ABSTRACT

Disclosed is a screen configuring method of an electronic device. The screen configuring method may include displaying a first application execution screen, obtaining a first area of the first application execution screen, displaying a camera application execution screen in the first area; obtaining an image displayed on the camera application execution screen, and reflecting the obtained image to the first application.

### RELATED APPLICATION(S)

This application claims the priority under 35 U.S.C. §119(a) to Korean Application Serial No. 10-2014-0132207, which was filed in the Korean Intellectual Property Office on Oct. 1, 2014, the entire content of which is hereby incorporated by reference.

### BACKGROUND

The present disclosure relates to configuring a screen of an electronic device.

Recently, electronic devices that may store and execute various applications, such as, a smart phone, a PDA, or the like, have been actively developed. An electronic device may include a camera module, and accordingly, a user may operate the electronic device to photograph and store a desired image. A conventional electronic device may store a camera application associated with a camera module. The electronic device may display a camera application execution screen including a camera photographing command icon, a preview image, or the like, after executing the camera application. The electronic device may store a preview image that is displayed at a point in time when the camera photographing command icon is selected.

### SUMMARY

An electronic device may reflect a photographed image to a first application. In this instance, the electronic device photographs and stores an image by executing a camera application while executing the first application, and reflects the photographed image by executing the first application again.

The present disclosure may provide a screen configuring method, an electronic device, and a storage medium, which displays a camera application in a part of a first application, and reflects a photographed image to a location where the camera application is executed.

According to various embodiments of the present disclosure, a method of configuring a screen is provided. The method includes displaying a first application execution screen, obtaining a first area of the first application execution screen, displaying a camera application execution screen in the first area, obtaining an image displayed on the camera application execution screen, and reflecting the obtained image to the first application.

According to various embodiments of the present disclosure, an electronic device is provided. The electronic device includes a display to display a first application execution screen, and a processor to execute a control to obtain a first area of the first application execution screen and to display a camera application execution screen in the first area, and to execute a control to obtain an image displayed on the camera application execution screen and to reflect the obtained image to a first application.

According to various embodiments of the present disclosure, a storage medium that stores instructions. The instructions include displaying a first application execution screen, obtaining a first area of the first application execution screen, displaying a camera application execution screen in the first area, obtaining an image displayed on the camera application execution screen, and reflecting the obtained image to a first application.

According to various embodiments of the present disclosure, a method of configuring a screen is provided. The method includes generating a first surface associated with a first application, generating a second surface associated with a second application, flinging the first surface and the second surface, and executing outputting, generating a third surface by reflecting data of the second application to the first surface, and outputting the third surface.

According to various embodiments of the present disclosure, a method of configuring a screen is provided. The method includes displaying a first application execution screen, displaying a second application execution screen on a first area of the first application execution screen, obtaining data from the second application and location information of the first area, and reflecting the data to the first application execution screen, based on the location information of the first area.

According to various embodiments of the present disclosure, an electronic device is provided. The electronic device includes a display to display a first application execution screen, and to display a second application execution screen in a first area of the first application execution screen, and a processor to obtain data from the second application and location information of the first area, and reflecting the data to the first application execution screen, based on the location of the first area.

According to various embodiments of the present disclosure, there is provided a screen configuring method, an electronic device, and a storage medium, which displays a camera application in a part of a first application, and reflects a photographed image to a location where the camera application is executed.

Accordingly, unlike the conventional method that photographs and stores an image by executing a camera application while executing a first application, and reflects the photographed image by executing again the first application, the method may directly reflect a photographed image to the first application.

According to various embodiments of the present disclosure, there are provided a screen configuring method, an electronic device, and a storage medium, which directly reflect, to a first area of the first application execution screen, output data of a second application that has been displayed in the first area.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates a network environment including an electronic device according to various embodiments of the present disclosure;

FIG. 2 is a block diagram of a program module according to various embodiments of the present disclosure;

FIG. 3 is a block diagram of a screen configuring module of an electronic device according to various embodiments of the present disclosure;

FIG. 4A is a flowchart illustrating a screen configuring method according to various embodiments of the present disclosure;

FIG. 4B is a flowchart illustrating a screen configuring method according to various embodiments of the present disclosure;

FIGS. 5A to 5C illustrate screen configurations of an electronic device according to various embodiments of the present disclosure;

FIG. 6A is a flowchart illustrating a screen configuring method according to various embodiments of the present disclosure;

FIG. 6B is a flowchart illustrating a screen configuring method according to various embodiments of the present disclosure;

FIGS. 7A and 7B illustrate screen configurations of an electronic device according to various embodiments of the present disclosure;

FIG. 8 is a flowchart illustrating a screen configuring method according to various embodiments of the present disclosure;

FIG. 9 is a flowchart illustrating a screen configuring method according to various embodiments of the present disclosure;

FIGS. 10A and 10B illustrate screen configurations of an electronic device according to various embodiments of the present disclosure;

FIG. 11 is a flowchart illustrating a screen configuring method according to various embodiments of the present disclosure;

FIGS. 12A to 12D illustrate screen configurations of an electronic device according to various embodiments of the present disclosure;

FIG. 13 is a flowchart illustrating a screen configuring method according to various embodiments of the present disclosure;

FIGS. 14A to 14C illustrate screen configurations of an electronic device according to various embodiments of the present disclosure;

FIG. 15 is a flowchart illustrating a screen configuring method according to various embodiments of the present disclosure;

FIG. 16 is a conceptual diagram illustrating a surface flinger process according to various embodiments of the present disclosure;

FIG. 17 is a conceptual diagram illustrating middleware or framework according to the present disclosure;

FIG. 18 is a flowchart illustrating a method of processing data according to various embodiments of the present disclosure;

FIGS. 19A and 19B illustrate screen configurations of an electronic device according to various embodiments of the present disclosure; and

FIG. 20 is a block diagram 2000 of an electronic device 2001 according to various embodiments of the present disclosure.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

In the present disclosure, the expression “have”, “may have”, “include” or “may include” refers to existence of a corresponding feature (e.g., numerical value, function, operation, or components such as elements), and does not exclude existence of additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. The above expressions are used merely for the purpose of distinguishing an element from the other elements. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposed between them. In contrast, it may be understood that when an element (e.g., first element) is referred to as being “directly connected,” or “directly coupled” to another element (second element), there is no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to.” For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well, unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary are to be interpreted to have the meanings equal to the contextual meanings in the relevant field of the art, and are not to be interpreted to have ideal or excessively formal meanings unless clearly defined in the present disclosure. In some cases, even the term defined in the present disclosure should not be interpreted to exclude embodiments of the present disclosure.

For example, the electronic device may include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device (e.g., a head-mounted-device (HMD) such as electronic glasses, electronic clothes, an electronic bracelet, an electronic necklace, an electronic appcessory, electronic tattoos, or a smart watch).

According to some embodiments, the electronic device may be a smart home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or an internet of things device (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

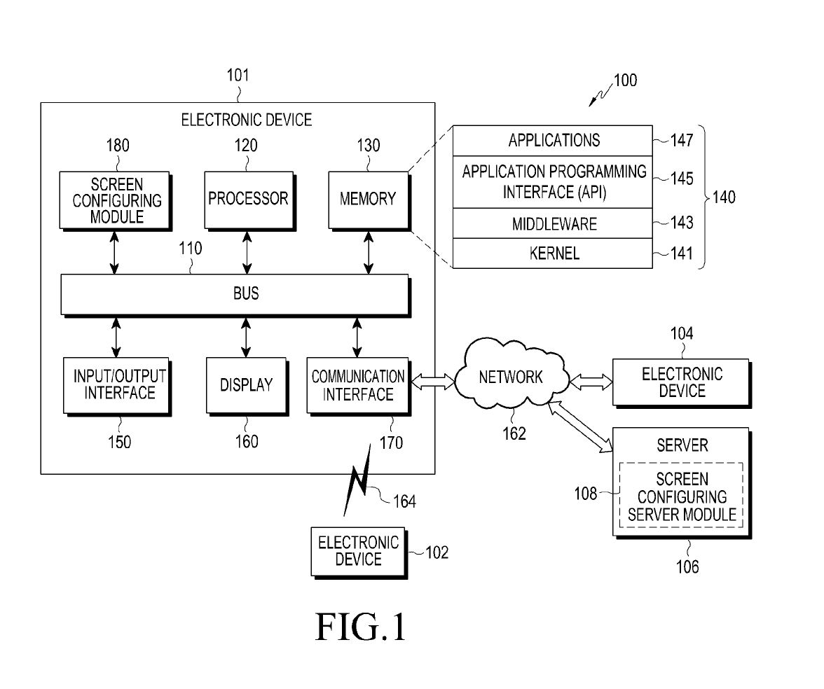

Referring to FIG. 1, an electronic device 101 within a network environment 100 according to various embodiments is disclosed. The electronic device 101 may include a bus 110, a processor 120, a memory 130, an input/output interface 150, a display 160, a communication interface 170, and a screen configuring module 180. In an embodiment of the present disclosure, the electronic device 101 may omit at least some of the above components or further include other components.

The bus 110 may include a circuit for connecting the components 120 to 180 and transmitting communication between the components (e.g., control messages and/or data).

The processor 120 may include one or more of a Central Processing Unit (CPU), an Application Processor (AP), and a Communication Processor (CP). The processor 120 may control, for example, one or more other components of the electronic device 101 and/or process an operation or data related to communication. The processor 120 may be referred to as a controller, or may include a controller as a part thereof.

The memory 130 may include a volatile memory and/or a non-volatile memory. The memory 130 may store, for example, commands or data related to at least one other component of the electronic device 101. According to an embodiment of the present disclosure, the memory 130 may store software and/or a program 140. The program 140 may include a kernel 141, middleware 143, an Application Programming Interface (API) 145, and/or an application program (or “application”) 147. At least some of the kernel 141, the middleware 143, and the API 145 may be referred to as an Operating System (OS).

The kernel 141 may control or manage system resources (e.g., the bus 110, the processor 120, the memory 130, or the like) used for executing an operation or function implemented by other programs (e.g., the middleware 143, the API 145, or the application 147). Furthermore, the kernel 141 may provide an interface through which the middleware 143, the API 145, or the application 147 may access individual components of the electronic device 101 to control or manage system resources.

The middleware 143 may serve as, for example, an intermediary such that the API 145 or the application 147 may communicate with the kernel 141 to transmit/receive data. Furthermore, in regard to task requests received from the application 147, the middleware 143 may perform a control (e.g., scheduling or load balancing) for the task requests using, for example, a method of assigning at least one application a priority for using the system resources (e.g., the bus 110, the processor 120, the memory 130, or the like) of the electronic device 101.

The API 145 is an interface by which the application 147 controls functions provided from the kernel 141 or the middleware 143, and may include, for example, at least one interface or function (e.g., instructions) for file control, window control, image processing, or text control.

In the specification, an application may be referred to as an application program.

The input/output interface 150 may serve as an interface which may transmit instructions or data input from the user or another external device to other component(s) of the electronic device 101. Further, the input/output interface 150 may output instructions or data received from another component(s) of the electronic device 101 to the user or another external device.

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 160 may display various types of contents (e.g., text, images, videos, icons, or symbols) for users. The display 160 may include a touch screen, and may receive, for example, a touch input, a gesture input, a proximity input, or a hovering input using an electronic pen or a user's body part.

The communication interface 170 may configure communication between, for example, the electronic device 101 and an external device (e.g., a first external electronic device 102, a second external electronic device 104, or a server 106). For example, the communication interface 170 may be connected to a network 162 through wireless or wired communication, and may communicate with the external device (e.g., the external electronic device 104 or the server 106).

The wireless communication may include, for example, at least one of LTE, LTE-A, CDMA, WCDMA, UMTS, WiBro, and GSM as a cellular communication protocol. The wired communication may include at least one of, for example, a Universal Serial Bus (USB), a High Definition Multimedia Interface (HDMI), Recommended Standard 232 (RS-232), a Plain Old Telephone Service (POTS), and the like. The network 162 may include at least one of communication networks such as a computer network (e.g., a LAN or a WAN), the Internet, and a telephone network.

Each of the first and second external electronic devices 102 and 104 may be a device which is the same as or different from the electronic device 101. According to an embodiment of the present disclosure, the server 106 may include a group of one or more servers. According to various embodiments of the present disclosure, all or some of the operations performed by the electronic device 101 may be performed by another electronic device or a plurality of electronic devices (e.g., the electronic device 102 or 104 or the server 106). According to an embodiment of the present disclosure, when the electronic device 101 should perform some functions or services automatically or by request, the electronic device 101 may request another device (e.g., the electronic device 102 or 104 or the server 106) to perform at least some of the functions related to the functions or services, instead of performing the functions or services by itself. The other electronic device (e.g., the electronic device 102 or 104 or the server 106) may carry out the requested function or the additional function, and transfer the result to the electronic device 101. The electronic device 101 may provide the requested functions or services based on the received result as it is, or after additionally processing the received result. To this end, for example, cloud computing, distributed computing, or client-server computing technology may be used.

According to an embodiment of the present disclosure, the screen configuring module 180 may support driving of the electronic device 101 by performing at least one of the operations (or functions) implemented by the electronic device 101. For example, the server 106 may include a screen configuration server module 108 capable of supporting the screen configuring module 180 implemented in the electronic device 101. For example, the screen configuration server module 108 may include at least one component of the screen configuring module 180, and may execute at least one of the operations that the screen configuring module 180 executes (e.g., executes at least one of the operations for the screen configuring module 180).

The screen configuring module 180 may process at least some of the information obtained from other components (e.g., at least one of the processor 120, the memory 130, the input/output interface 150, and the communication interface 170) and utilize the same in various manners. For example, the screen configuring module 180 may control at least some functions of the electronic device 101, by using the processor 120 or independently therefrom, so that the electronic device 101 may work with other electronic devices (e.g., the electronic device 104 or the server 106). The screen configuring module 180 may be integrated into the processor 120 or the communication interface 170. According to an embodiment of the present disclosure, at least one component element of the screen configuring module 180 may be included in the server 106 (e.g., the screen configuration server module 108), and at least one operation implemented in the screen configuring module 180 may be supported by the server 106.

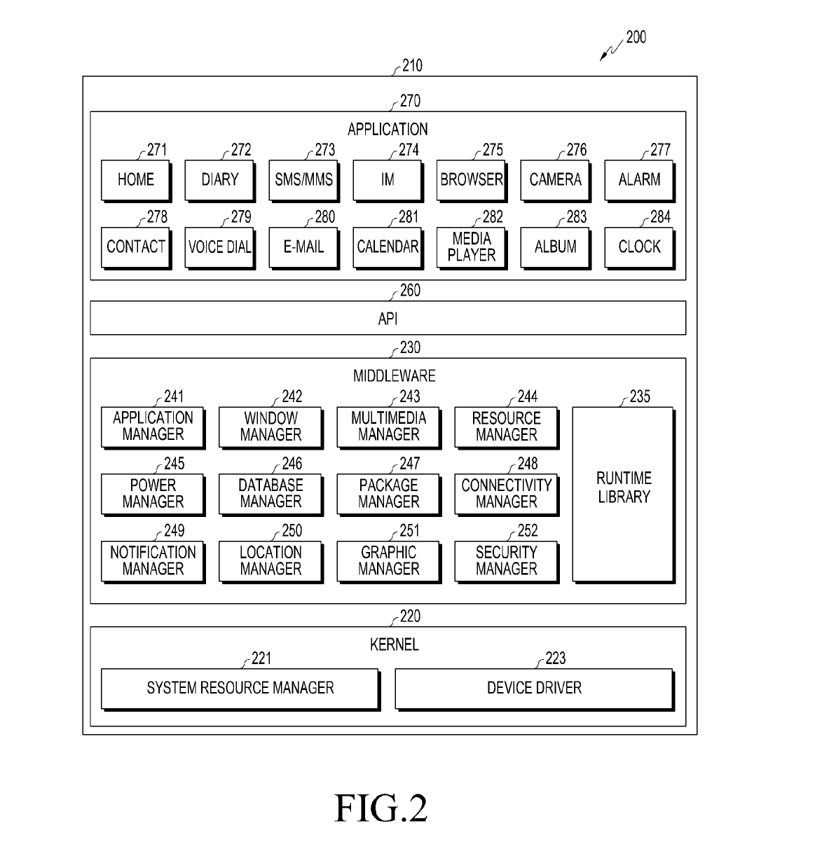

FIG. 2 is a block diagram 200 of a program module 210 according to various embodiments of the present disclosure. According to an embodiment of the present disclosure, the program module 210 (e.g., the program 140) may include an Operating System (OS) for controlling resources related to an electronic device (e.g., the electronic device 101) and/or various applications (e.g., the application 147) executed in the operating system. The operating system may be, for example, Android, iOS, Windows, Symbian, Tizen, Bada, or the like.

The program module 210 may include a kernel 220, middleware 230, an Application Programming Interface (API) 260, and/or an application 270. At least some of the program module 210 may be preloaded in the electronic device or downloaded from a server (e.g., the server 106).

The kernel 220 (e.g., the kernel 141 of FIG. 1) may include, for example, a system resource manager 221 or a device driver 223. The system resource manager 221 may control, allocate, or collect the system resources. According to an embodiment of the present disclosure, the system resource manager 221 may include a process manager, a memory manager, a file system manager, or the like. The device driver 223 may include, for example, a display driver, a camera driver, a Bluetooth driver, a shared-memory driver, a USB driver, a keypad driver, a Wi-Fi driver, an audio driver, or an Inter-Process Communication (IPC) driver.

The middleware 230 may provide a function required by the application 270 in common or provide various functions to the application 270 through the API 260 so that the application 270 may efficiently use limited system resources of the electronic device. According to an embodiment of the present disclosure, the middleware 230 (e.g., the middleware 143) may include, for example, at least one of a runtime library 235, an application manager 241, a window manager 242, a multimedia manager 243, a resource manager 244, a power manager 245, a database manager 246, a package manager 247, a connectivity manager 248, a notification manager 249, a location manager 250, a graphic manager 251, and a security manager 252.

The run time library 235 may include, for example, a library module that a compiler uses in order to add new functions through a programming language while the application 270 is executed. The run time library 235 may perform input/output management, memory management, a function for an arithmetic function, or the like.

The application manager 241 may manage, for example, a life cycle of at least one of the applications 270. The window manager 242 may manage a GUI resource used in a screen. The multimedia manager 243 may recognize a format required for reproducing various media files, and encode or decode a media file using a codec appropriate for the corresponding format. The resource manager 244 may manage resources such as a source code, a memory, a storage space, or the like of at least one of the applications 270.

The power manager 245 may operate together with a Basic Input/Output System (BIOS) to manage a battery or power and may provide power information required for the operation of the electronic device. The database manager 246 may generate, search for, or change a database to be used by at least one of the applications 270. The package manager 247 may manage the installation or the updating of applications distributed in a form of a package file.

For example, the connectivity manager 248 may manage wireless connections, such as Wi-Fi or Bluetooth. The notification manager 249 may display or notify an event such as reception of a message, an appointment, and a proximity notification to a user without disturbance. The location manager 250 may manage location information of the electronic device. The graphic manager 251 may manage graphic effects to be provided to a user and user interfaces related to the graphic effects. The security manager 252 may provide various security functions required for system security, user authentication, or the like. According to an embodiment of the present disclosure, when an electronic device (e.g., the electronic device 101) has a call function, the middleware 230 may further include a telephony manager for managing a voice call function or a video call function of the electronic device.

The middleware 230 may include a middleware module for forming a combination of various functions of the aforementioned components. The middleware 230 may provide a module specified for each type of operating system, in order to provide a differentiated function. In addition, a few existing components may be dynamically removed from the middleware 230, or new components may be added to the middleware 230.

The API 260 (e.g., the API 145), which is a set of API programming functions, may be provided in a configuration different for each operating system. For example, in the case of Android or iOS, one API set may be provided for each platform, and in the case of Tizen, two or more API sets may be provided for each platform.

The application 270 (e.g., the application 147) may include, for example, one or more applications that may provide functions such as home 271, dialer 272, SMS/MMS 273, Instant Message (IM) 274, browser 275, camera 276, alarm 277, contacts 278, voice dialer 279, email 280, calendar 281, media player 282, album 283, clock 284, health care (e.g., measure exercise quantity or blood sugar) (not pictured), or environmental information (e.g., atmospheric pressure, humidity, or temperature information) (not pictured).

According to an embodiment, the application 270 may include an application (hereinafter, referred to as an “information exchange application” for convenience of the description) supporting exchanging information between the electronic device (e.g., the electronic device 101) and an external electronic device (e.g., the electronic devices 102 and 104). The information exchange application may include, for example, a notification relay application for transmitting specific information to the external electronic device, or a device management application for managing the external electronic device.

For example, the notification relay application may include a function of transferring to an external electronic device (e.g., the electronic device 102 or 104) notification information generated from other applications of the electronic device 101 (e.g., an SMS/MMS application, an e-mail application, a health management application, an environmental information application, or the like). Further, a notification relay application may receive notification information from, for example, the external electronic device, and provide the received notification information to the user. The device management application may manage (e.g., install, delete, or update), for example, a function of at least a part of an external electronic device (e.g., the electronic device 102 or 104) communicating with the electronic device (e.g., turning on/off the external electronic device itself (or some elements thereof) or adjusting brightness (or resolution) of a display), applications executed in the external electronic device, or services provided from the external electronic device (e.g., a telephone call service or a message service).

According to an embodiment of the present disclosure, the application 270 may include an application (e.g., health management application) designated according to attributes (e.g., attributes of the electronic device such as the type of electronic device which corresponds to a mobile medical device) of the external electronic device (e.g., the electronic device 102 or 104). According to an embodiment of the present disclosure, the application 270 may include an application received from the external electronic device (e.g., the server 106, or the electronic device 102 or 104). According to an embodiment of the present disclosure, the application 270 may include a preloaded application or a third party application which may be downloaded from the server. Names of the components of the program module 210 in the above described embodiment may vary depending on a type of operating system.

According to various embodiments of the present disclosure, at least some of the program module 210 may be embodied as software, firmware, hardware, or a combination of two or more thereof. At least some of the program module 210 may be implemented (e.g., executed) by, for example, the processor (e.g., the processor 120). At least some of the program module 210 may include, for example, a module, a program, a routine, sets of instructions, a process, or the like, for performing one or more functions.

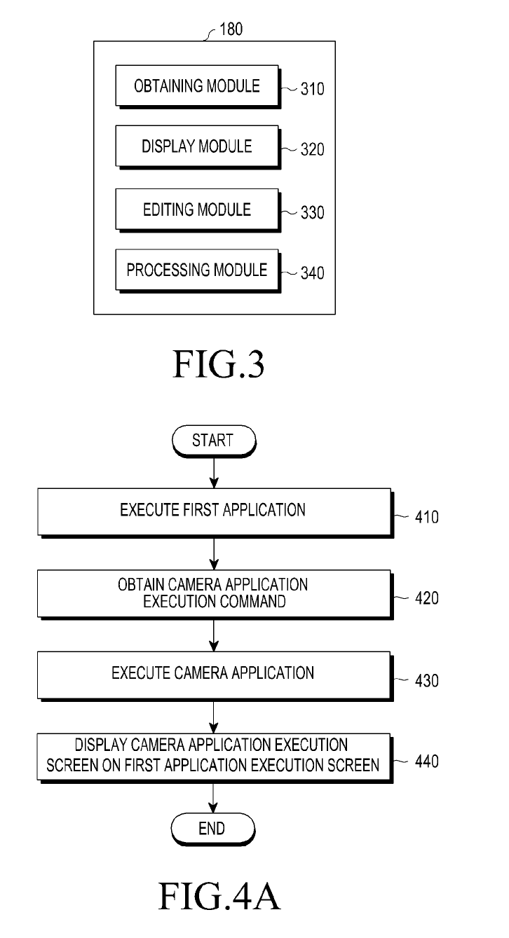

FIG. 3 is a block diagram of the screen configuring module 180 of an electronic device (e.g., the electronic device 101) according to various embodiments of the present disclosure. Referring to FIG. 3, the screen configuring module 180 may include at least a few or all of a display module 320, an obtaining module 310, an editing module 330, and a processing module 340. The screen configuring module 180 may be provided separately from a processor (e.g., the processor 120) or all or a part of the screen configuring module 180 may be integrated into the processor.

The display module 320 according to various embodiments of the present disclosure may display a first application execution screen. The obtaining module 310 may obtain a first area of the first application execution screen. The display module 320 may display a camera application execution screen on the first area. The obtaining module 310 may obtain an image displayed on the camera application execution screen. The processing module 340 may reflect the obtained image to a first application.

According to an embodiment of the present disclosure, the display module 320 may display the obtained image on the first area of the first application execution screen, and may display, for example, a preview screen that displays an obtained image in real time, and a photographing command icon.

According to an embodiment of the present disclosure, the obtaining module 310 may obtain an image that is displayed on the preview screen, in response to selection of the photographing command icon.

According to an embodiment of the present disclosure, the editing module 330 may edit the camera application execution screen. For example, when the obtaining module 310 obtains a location change command to change a display location of the camera application execution screen, the editing module 330 may control the display module 320 to display the camera application execution screen by changing the display location based on the obtained location change command.

According to an embodiment of the present disclosure, when the obtaining module 310 obtains an editing command to change a size of the camera application execution screen, the editing module 330 displays the camera application execution screen by changing the size of the camera application execution screen or changing a size of an object displayed in the camera application execution screen, based on the editing command.

According to an embodiment of the present disclosure, when the obtaining module 310 obtains a crop command to crop a first area of an obtained entire image, the editing module 330 may crop the first area of the camera application execution screen based on the crop command. The display module 320 may display the cropped first area. Alternatively, the display module 320 may display the camera application execution screen by adjusting the size of the camera application execution screen based on a size of the first area.

According to various embodiments of the present disclosure, the processing module 340 may generate a first surface associated with the first application, and may generate a second surface associated with a second application. Also, the processing module 340 may fling the first surface and the second surface, and execute an outputting function. The processing module 340 may generate a third surface by reflecting data from the second application to the first surface, and output the third surface.

According to an embodiment of the present disclosure, the processing module 340 may obtain a location of a first area of the second surface, and may reflect the data to a location of the first surface, which corresponds to the first area, so as to generate the third surface.

According to various embodiments of the present disclosure, the display module 320 may display the first application execution screen, and may display a second application execution screen on the first area of the first application execution screen. The obtaining module 310 may obtain the data from the second application and location information of the first area. The processing module 340 may reflect the data to the first application execution screen, based on the location information of the first area.

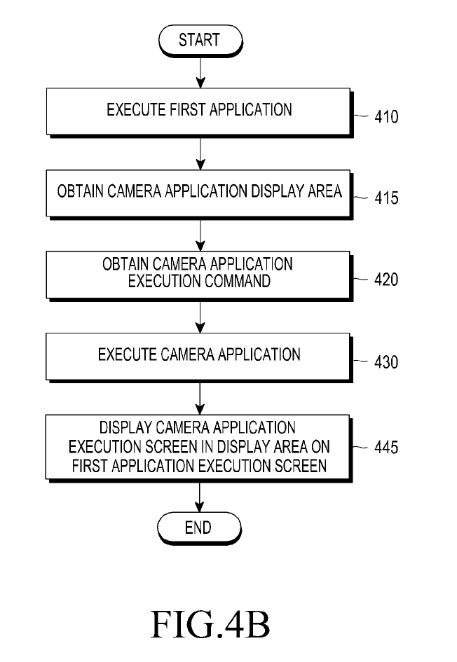

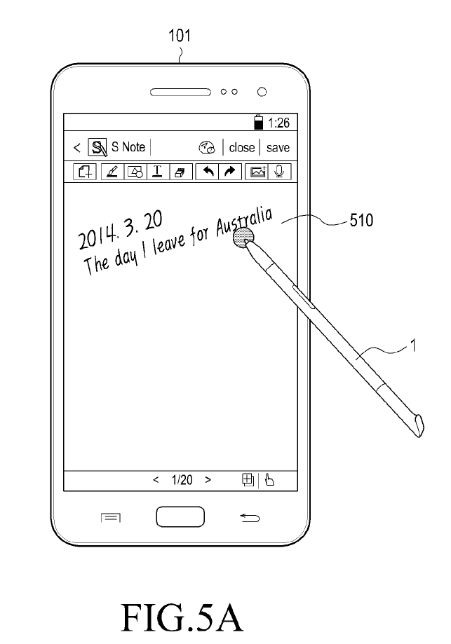

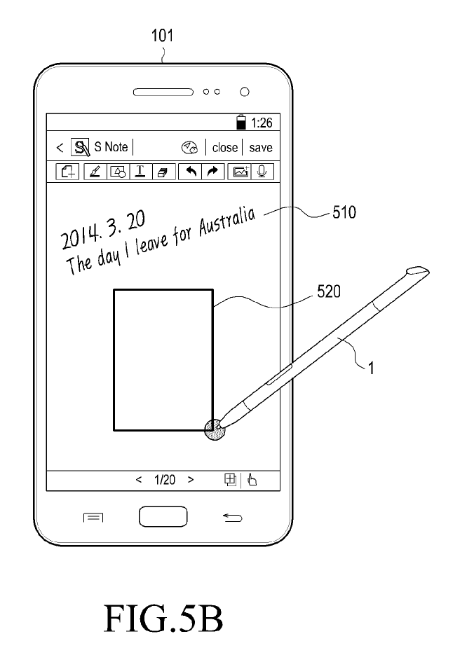

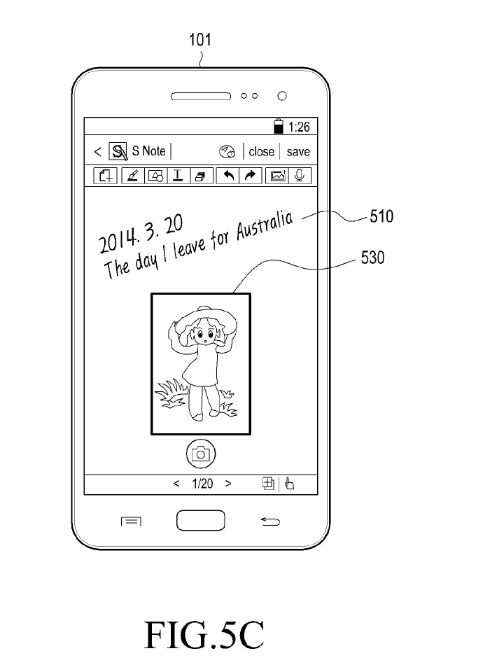

FIG. 4A is a flowchart illustrating a screen configuring method according to various embodiments of the present disclosure. The screen configuring method of FIG. 4A will be described in detail with reference to FIGS. 5A to 5C. FIGS. 5A to 5C illustrate a screen configuration of an electronic device according to various embodiments of the present disclosure.

In operation 410, the electronic device 101 executes a first application. For example, as illustrated in FIG. 5A, the electronic device 101 may execute the first application, and may display a first application execution screen 510 in full-screen display. In the embodiment of FIG. 5A, the first application may be, for example, a memo application, and those skilled in the art may readily understand that a type of the first application is not limited thereto. A user may input a command onto the first application execution screen 510 using an input object such as an electronic pen 1 or the like. In the embodiment of FIG. 5A, the user may input a desired memo onto a display using the electronic pen 1, as a drag gesture. The first application may process the input drag gesture and display an output result corresponding thereto. For example, the first application may output the first application execution screen 510 that displays lines, to a portion where the input drag gesture is touched in the display.

In operation 420, the electronic device 101 obtains a camera application execution command. For example, in an embodiment of FIG. 5B, the electronic device 101 may receive an input of a drag gesture 520 in a form set in advance, from the electronic pen 1. The electronic device 101 may set the drag gesture 520 in advance, as a camera application execution command. The first application may set the drag gesture 520 in advance as the camera application execution command. In this instance, the first application may transfer the corresponding camera application execution command to an activity manager. The activity manager may receive the camera application execution command, and may execute a camera application based on the same. According to another embodiment of the present disclosure, the drag gesture 520 may be set in advance as the camera application execution command by the activity manager. The gesture 520 received in the display may not be dispatched to the first application, but may be directly processed by the activity manager of middleware. The activity manager may execute the camera application based on the obtained camera application execution command.

The drag gesture 520 in a form set in advance, for example, a drag gesture provided in a quadrangular shape as shown in FIG. 5B, is merely an example, and those skilled in the art may readily understand that a type, a size, or a form of a camera application execution command may not be limited thereto. Although not illustrated, when the drag gesture 520 in a form set in advance is input, the electronic device 101 may further display a camera application execution icon inside an area formed by the drag gesture 520. In this instance, when the camera application execution icon is selected, the electronic device 101 may execute the camera application.

In operation 430, the electronic device 101 executes the camera application. The electronic device 101 may execute the camera application in response to the camera application execution command, and the process of executing the camera application has been described above.

In operation 440, the electronic device 101 displays a camera application execution screen on the first application execution screen 510. For example, as illustrated in FIG. 5C, the electronic device 101 may display a camera application execution screen 530. According to an embodiment of the present disclosure, the electronic device 101 may display the camera application execution screen 530 to cover the first application execution screen 510. In particular, the electronic device 101 may display the camera application execution screen 530, instead of the first application execution screen 510, in a portion where the camera application execution screen 530 and the first application execution screen 510 overlap. According to an embodiment of the present disclosure, the camera application execution screen 530 may include a preview screen and a photographing command icon. The preview screen may be a screen for displaying an image obtained from a camera module (not illustrated), in real time. When the photographing command icon is selected, the electronic device 101 may select an image displayed on the preview screen.

FIG. 4B is a flowchart illustrating a screen configuring method according to various embodiments of the present disclosure. Operations 410, 420, and 430 of FIG. 4B have been described in association with FIG. 4A, and thus, the descriptions thereof will be omitted.

When the first application is executed in operation 410, the electronic device 101 obtains a camera application display area in operation 415. For example, the drag gesture 520 of FIG. 5B may include a display area of the camera application.

In operation 445, the electronic device 101 displays the camera application execution screen in the display area on the first application execution screen. For example, as illustrated in FIG. 5C, the electronic device 101 may display the camera application execution screen 530 in a display area where the drag gesture 520 of FIG. 5B is formed.

According to an embodiment of the present disclosure, the electronic device 101 may transfer the obtained camera application display area to a window manager of middleware or a multi-window manager, and the window manager or the multi-window manager may dispose a window where the camera application is executed, on a window where the first application is executed, based on the obtained camera application display area. The activity manager, the window manager, and the multi-window manager as described above are merely examples, and those skilled in the art may readily understand that a screen configuration may be changed in various OSs. The scope of the right of the present disclosure may not be limited to the activity manger, the window manager, and the multi-window manager.

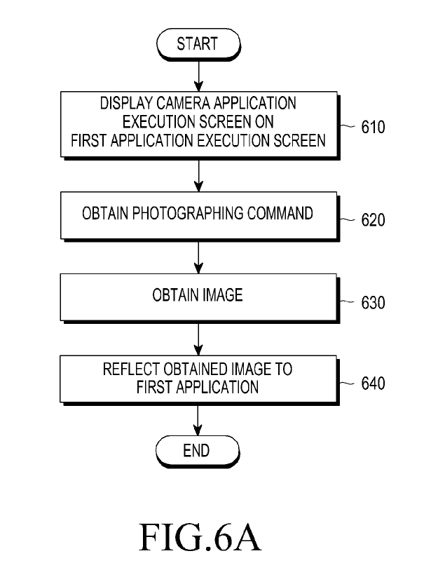

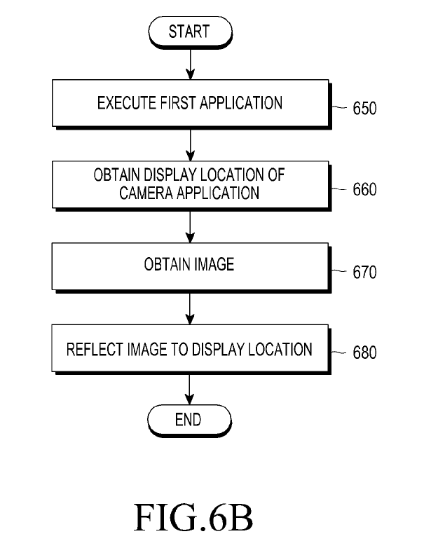

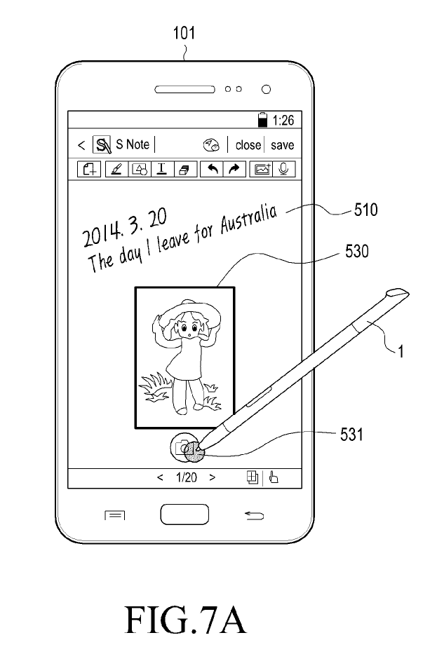

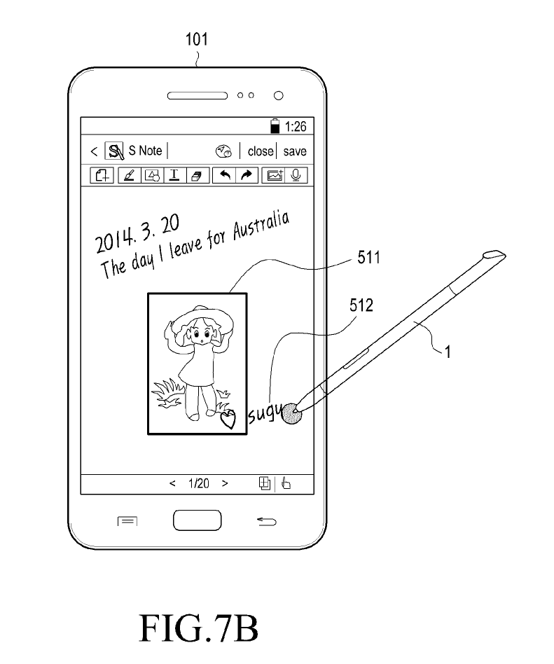

FIG. 6A is a flowchart illustrating a screen configuring method according to various embodiments of the present disclosure. The embodiment of FIG. 6A will be described in detail with reference to FIGS. 7A and 7B. FIGS. 7A and 7B illustrate screen configurations of an electronic device according to various embodiments of the present disclosure.

In operation 610, as illustrated in FIG. 7A, the electronic device 101 may display the camera application execution screen 530 on the first application execution screen 510.

In operation 620, a user may input a photographing command using, for example, the electronic pen 1. In an embodiment of FIG. 7A, a photographing command may be selection of a photographing command icon 531. The electronic device 101 may obtain the selection of the photographing command icon 531 so as to obtain a photographing command.

In operation 630, the electronic device 101 photographs and obtains an image based on the obtained photographing command. For example, the electronic device 101 may store an image that is displayed on a preview screen.

In operation 640, the electronic device 101 reflects the obtained image to the first application. Referring to FIG. 7B, the electronic device 101 may reflect an obtained image 511 to a first application screen 512. The electronic device 101 may transfer the obtained image 511 to the first application, and the first application may reflect the received obtained image 511 to the first application screen 512.

FIG. 6B is a flowchart illustrating a screen configuring method according to various embodiments of the present disclosure. The embodiment of FIG. 6B will be described in detail with reference to FIGS. 7A and 7B.

In operation 650, as illustrated in FIG. 7A, the electronic device 101 may display the camera application execution screen 530 on the first application execution screen 510.

In operation 660, the electronic device 101 obtains a display location of the camera application. In the embodiment of FIG. 7A, the electronic device 101 may obtain a display location of the camera application execution screen 530.

In operation 670, the electronic device 101 obtains an image through the camera application.

In operation 680, the electronic device 101 reflects the obtained image to the obtained camera application display location on the first application execution screen 512.

For example, the electronic device 101 may transfer the obtained image and the camera application display location to the first application. The first application may reflect the obtained image 511 to the first application execution screen 512, based on the camera application display location.

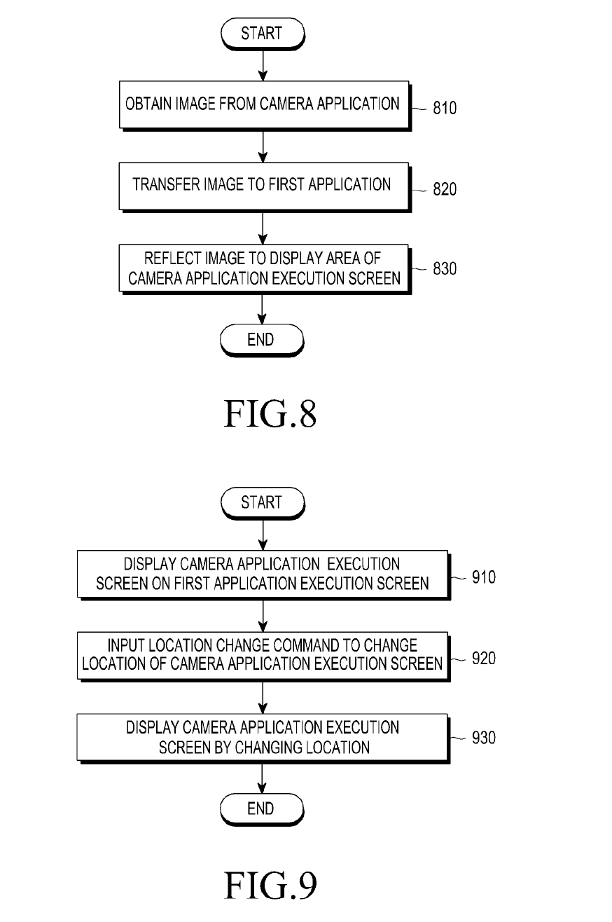

FIG. 8 is a flowchart illustrating a screen configuring method according to various embodiments of the present disclosure.

In operation 810, the electronic device 101 obtains an image through a camera application. The electronic device 101 may temporarily store the obtained image in, for example, a clipboard, or may store the obtained image in a storage module.

In operation 820, the electronic device 101 transfers the stored image to a first application. As described above, the electronic device 101 may transfer a display location of a camera application along with the stored image, to the first application.

In operation 830, the electronic device 101 reflects the transferred image to the display location, through the first application. The electronic device 101 may display a first application execution screen where an image is reflected.

Although the descriptions provide that the electronic device 101 reflects the image obtained from the camera application to the first application, this is merely an example. The electronic device 101 may reflect any data output from the camera application to the first application, irrespective of a type of the data. For example, the electronic device 101 may reflect a video photographed through the camera application to the first application execution screen, so as to display the video. In this instance, the electronic device 101 may transfer the video and the display location of the camera application to the first application. The electronic device 101 may reflect the video to a location on the first application execution screen, which corresponds to the camera application display location, so as to display the video.

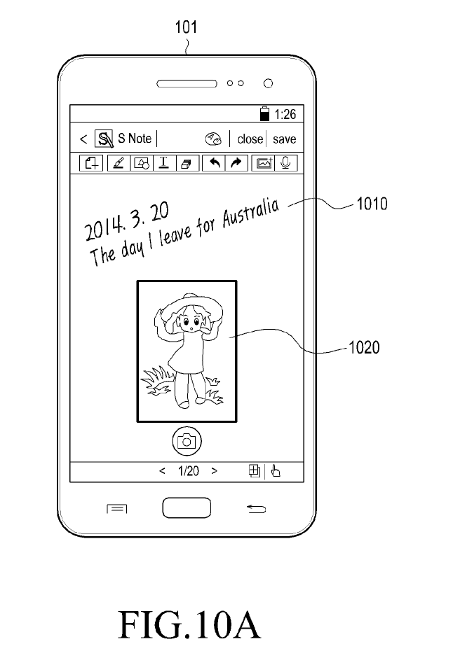

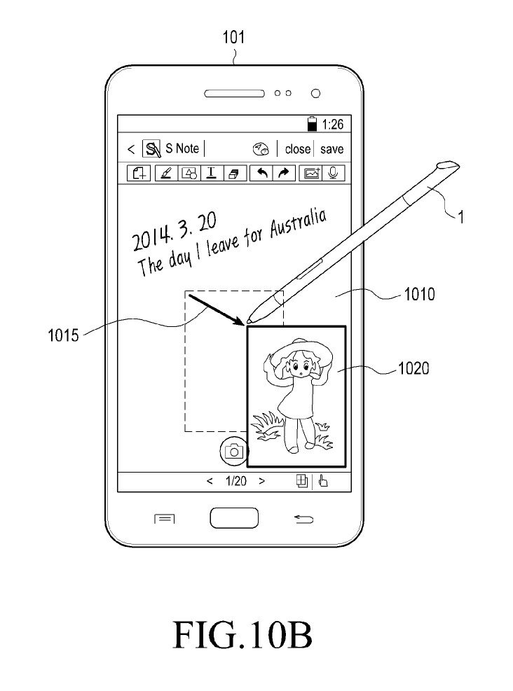

FIG. 9 is a flowchart illustrating a screen configuring method according to various embodiments of the present disclosure. The screen configuring method of FIG. 9 will be described in detail with reference to FIGS. 10A and 10B. FIGS. 10A and 10B illustrate screen configurations of an electronic device according to various embodiments of the present disclosure.

In operation 910, as illustrated in FIG. 10A, the electronic device 101 may display a camera application execution screen 1020 on a first application execution screen 1010.

In operation 920, the electronic device 101 receives a location change command associated with the camera application execution screen 1020. For example, in an embodiment of FIG. 10B, a drag gesture 1015 moving in a first direction from a point inside the camera application execution screen 1020 may be set as the location change command. The location change command as described above may be set in advance in, for example, a middleware end. Accordingly, the drag gesture starting from the application screen displayed on a display may not be dispatched to the corresponding application, but may be transferred to a window manager. The window manager may change a location of a window where the corresponding application is executed, based on the received drag gesture.

In operation 930, the electronic device 101 displays the camera application execution screen 1020 by changing the location, based on the location change command 1015. For example, as illustrated in FIG. 10B, the electronic device 101 may display the camera application execution screen 1020 by changing the location, based on at least one of a direction and a degree of the location change command 1015.

When a photographing command is input in the changed location, the electronic device 101 may reflect an obtained image to a location on the first application execution, which corresponds to the changed location.

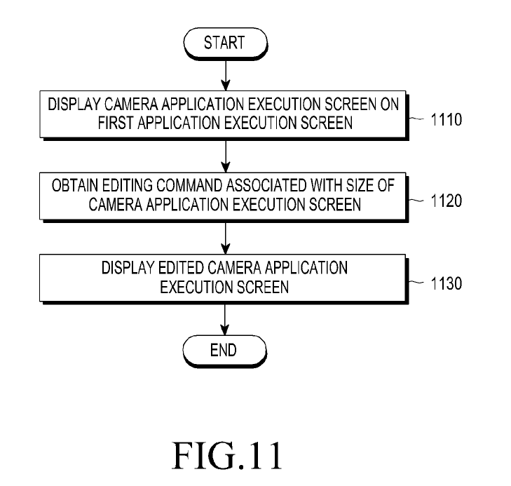

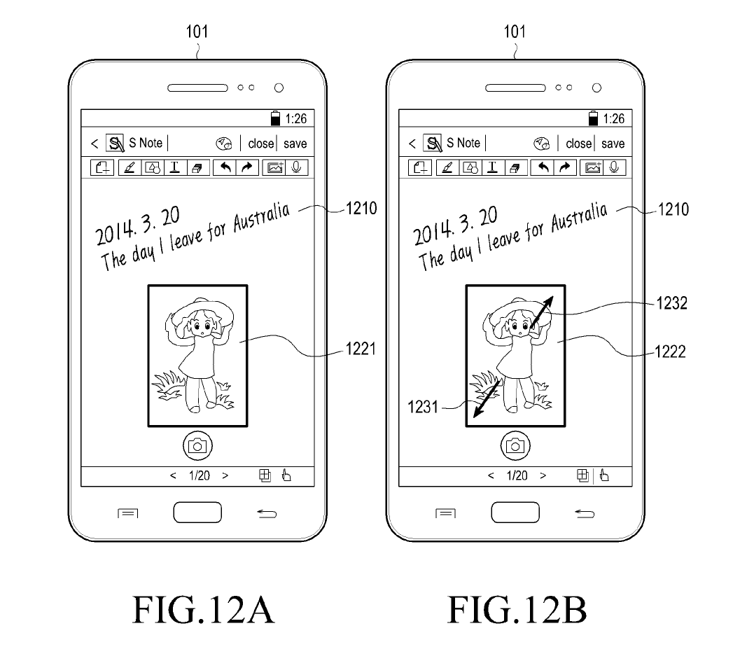

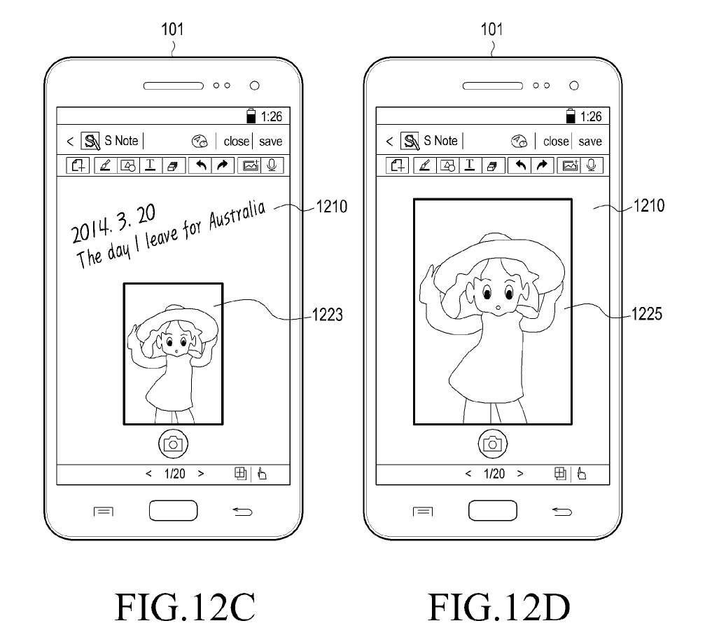

FIG. 11 is a flowchart illustrating a screen configuring method according to various embodiments of the present disclosure. The screen configuring method of FIG. 11 will be described in detail with reference to FIGS. 12A to 12D. FIGS. 12A to 12D illustrate screen configurations of an electronic device according to various embodiments of the present disclosure.

In operation 1110, as illustrated in FIG. 12A, the electronic device 101 may display a camera application execution screen 1221 on a first application execution screen 1210.

In operation 1120, the electronic device 101 receives an input of an editing command to change a size of the camera application execution screen 1221. For example, in an embodiment of FIG. 12B, a pinch-out gesture 1231 and 1232 moving in a first direction and a second direction respectively from points inside the camera application execution screen 1221 may be set as the editing command. The editing command as described above may be set in advance in, for example, a camera application. Accordingly, the pinch-out gesture 1231 and 1232 starting from an application screen displayed on a display may be dispatched to the camera application. The camera application may edit the camera application execution screen, based on the received pinch-out gesture 1231 and 1232. For example, the camera application may enlarge a camera application execution screen 1223, as illustrated in FIG. 12C. Particularly, the camera application may enlarge and display an object displayed in the camera application execution screen 1223.

In operation 1130, the electronic device 101 executes displaying by changing a size in association with the camera application execution screen 1223 based on the editing command 1231 and 1232. Although not illustrated, those skilled in the art may readily understand that the electronic device 101 may execute displaying by reducing the size associated with the camera application execution screen 1223 based on a different type of editing command.

When a photographing command is input in the enlarged state, the electronic device 101 may reflect an obtained image to the first application execution screen 1210.

FIG. 12D illustrates a screen configuration of an electronic device according to various embodiments of the present disclosure. As illustrated in FIG. 12D, the electronic device 101 receives an input of an editing command to change a size of a camera application execution screen 1225. For example, in an embodiment of FIG. 12B, a pinch-out gesture 1231 and 1232 moving in a first direction and a second direction respectively from points inside the camera application execution screen 1222 may be set as the editing command. The editing command as described above may be set in advance in, for example, a middleware end. Accordingly, the pinch-out gesture 1231 and 1232 starting from an application screen displayed on a display may not be dispatched to the corresponding application, but may be transferred to a window manager. The window manager may change a size of a window where the corresponding application is executed, based on the received drag gesture. Accordingly, the electronic device 101 may display the enlarged camera application execution screen 1225, as illustrated in FIG. 12D. When a photographing command is input in the enlarged state, the electronic device 101 may reflect an obtained image to the first application execution screen 1210. Although not illustrated, those skilled in the art may readily understand that the electronic device 101 may execute displaying by reducing the size of the camera application execution screen 1225 based on a different type of editing command.

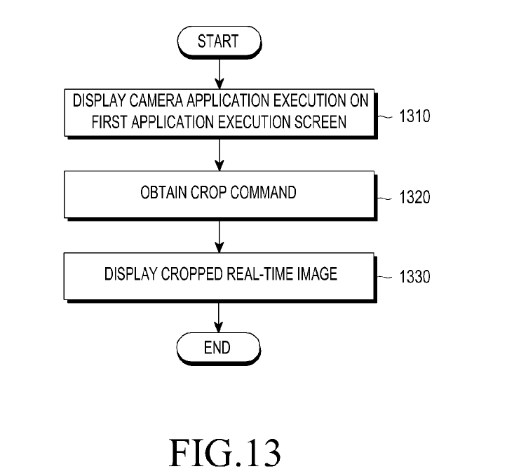

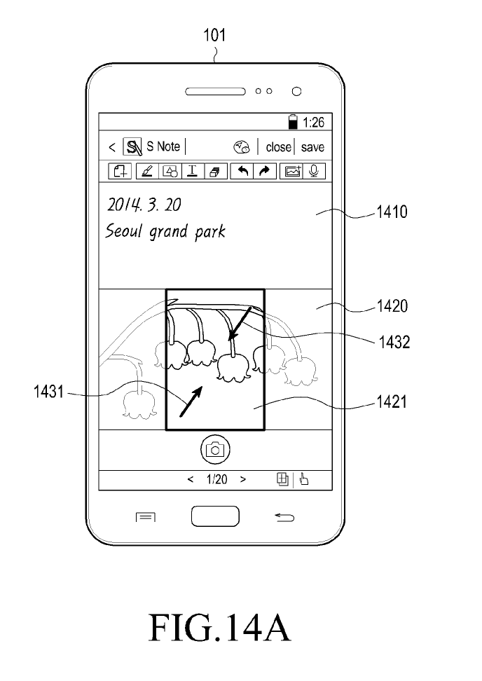

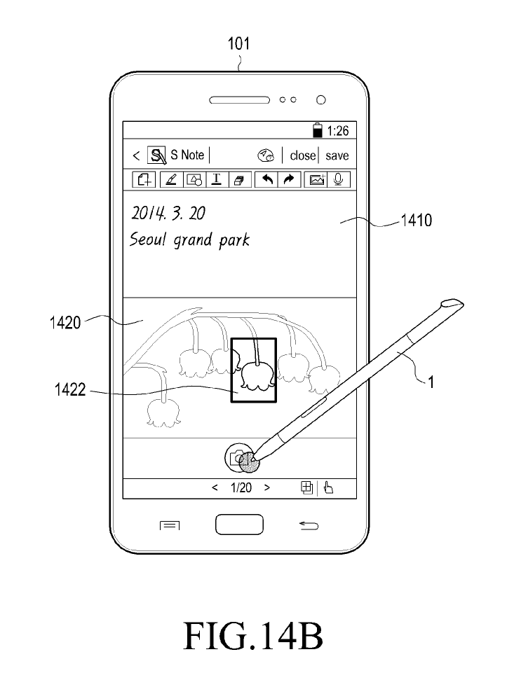

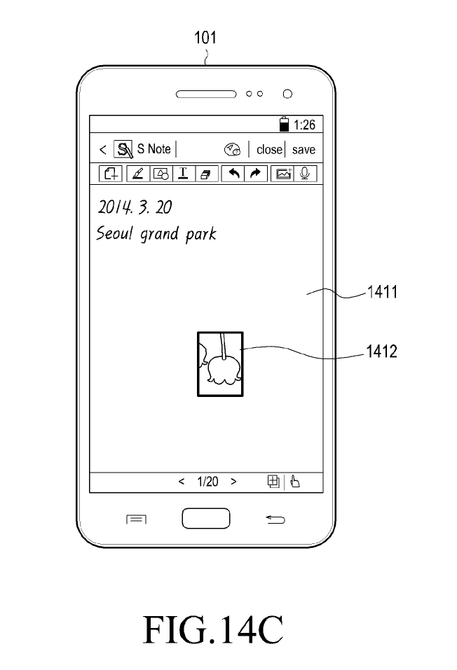

FIG. 13 is a flowchart illustrating a screen configuring method according to various embodiments of the present disclosure. The screen configuring method of FIG. 13 will be described in detail with reference to FIGS. 14A to 14C. FIGS. 14A to 14C illustrate screen configurations of an electronic device according to various embodiments of the present disclosure.

In operation 1310, as illustrated in FIG. 14A, the electronic device 101 may display a camera application execution screen 1421 on a first application execution screen 1410. Here, an image of a first area that is cropped from an entire image obtained through a camera module may be displayed on the camera application execution screen 1421.

In operation 1320, the electronic device 101 may receive a crop command to crop a second area which is different from the first area of the entire image 1420. For example, in an embodiment of FIG. 14A, a pinch-in gesture 1431 and 1432 moving in a first direction and a second direction respectively from points inside the camera application execution screen 1421 may be set as the crop command. The crop command as described above may be set in advance in, for example, a camera application or middleware. Accordingly, the pinch-in gesture 1431 and 1432 starting from an application screen displayed on a display may be dispatched to the camera application, or may be transferred to a window manager. The camera application may display a cropped camera application execution screen 1422 based on the received pinch-in gesture 1431 and 1432, as illustrated in FIG. 14B. Alternatively, the window manager may reduce and display the camera application execution 1422 itself.

In operation 1330, the electronic device 101 may display the camera application execution screen 1422 obtained by cropping the second area of the entire image 1420, based on the crop command.

As illustrated in FIG. 14C, when a photographing command is input, the electronic device 101 may reflect the cropped image to the first application execution screen 1411.

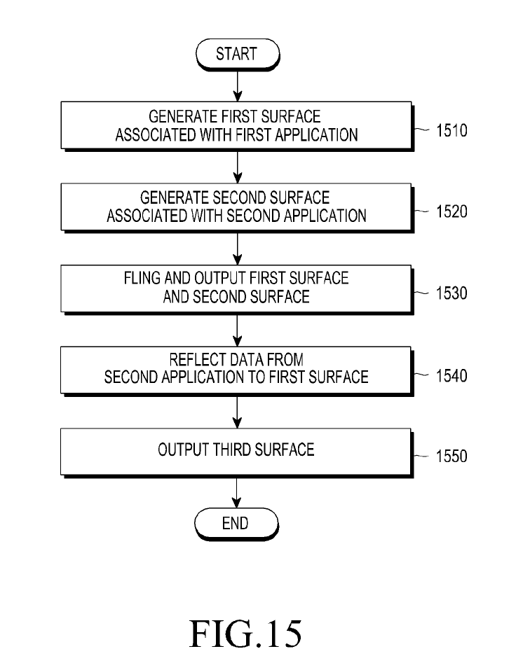

FIG. 15 is a flowchart illustrating a screen configuring method according to various embodiments of the present disclosure.

In operation 1510, the electronic device 101 generates a first surface associated with a first application.

In operation 1520, the electronic device 101 generates a second surface associated with a second application.

In operation 1530, the electronic device 101 may fling the first surface and the second surface, and execute an outputting function. The electronic device 101 may determine display priorities of the first surface and the second surface, and execute flinging to enable a surface with a higher display priority to be disposed on a surface with a lower display priority. Also, the electronic device 101 may also fling a background surface, in addition to the first surface and the second surface. Here, the surface may be a component element forming a screen displayed on the display of the electronic device 101. For example, a plurality of surfaces may be output respectively from a plurality of applications. A surface flinger may fling a plurality of surfaces, so as to output a single piece of image data. Each surface includes a display priority, and the surface flinger may execute flinging based on a corresponding display priority.

In operation 1540, the electronic device 101 may generate a third surface by reflecting data from the second application to the first surface. The third surface may be generated by the first application.

In operation 1550, the electronic device 101 outputs the third surface.

The electronic device 101 may obtain a first area from the second surface, and may generate the third surface by reflecting data from the second application to a first application execution screen, based on location information of the first area. That is, the electronic device 101 may generate the third surface by reflecting the data from the second application to a location corresponding to the first area of the first surface.

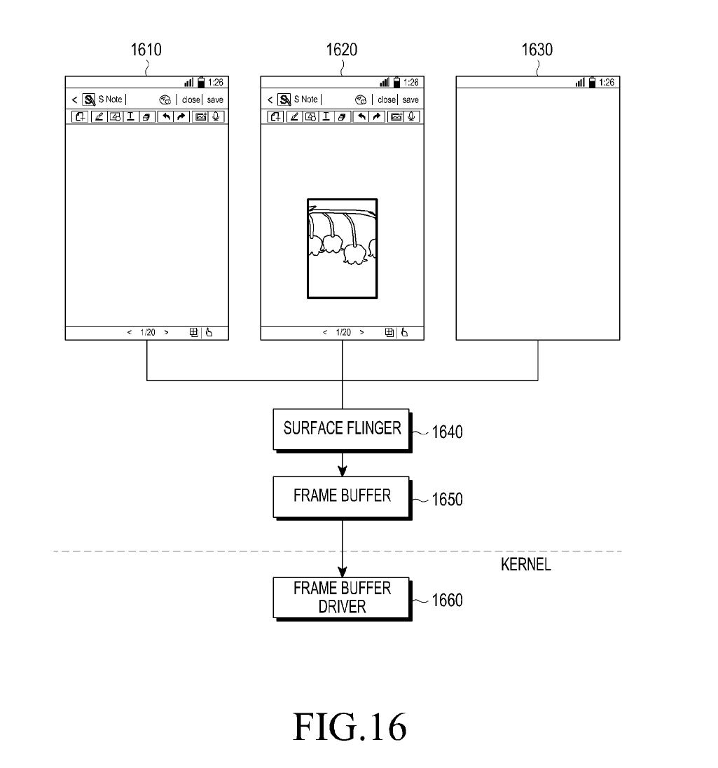

FIG. 16 is a conceptual diagram illustrating a surface fling process according to various embodiments of the present disclosure.

A surface flinger 1640 receives a first surface 1610 generated from a first application, a second surface 1620 generated from a second application, and a background surface 1630. The first surface 1610, the second surface 1620, and the background surface 1630 may be input into the surface flinger 1640 as a user processor. In an embodiment of FIG. 16, the first application may be, for example, a memo application, and the second application may be, for example, a camera application.

The surface flinger 1640 may determine display priorities of the first surface 1610, the second surface 1620, and the background surface 1630. In the embodiment of FIG. 16, it is assumed that the display priority of the second surface 1620 is higher than the display priority of the first surface 1610. For example, when the second application is executed while the first application is executed, the electronic device 101 may set the second surface 1620 from the second application to be higher than the first surface 1610.

The surface flinger 1640 disposes the second surface 1620 on the top based on the display priorities, disposes the first surface 1610 on the second bottom, and disposes the background surface 1630 on the very bottom. The surface flinger 1640 may output a display image which is a result of flinging, to a frame buffer 1650. The display image buffered to the frame buffer 1650 may be output to a frame buffer driver 1660 of a kernel end, and may be displayed on the display. Accordingly, the electronic device 101 may display the camera application execution screen on the first application execution screen, for example, as illustrated in FIG. 5C.

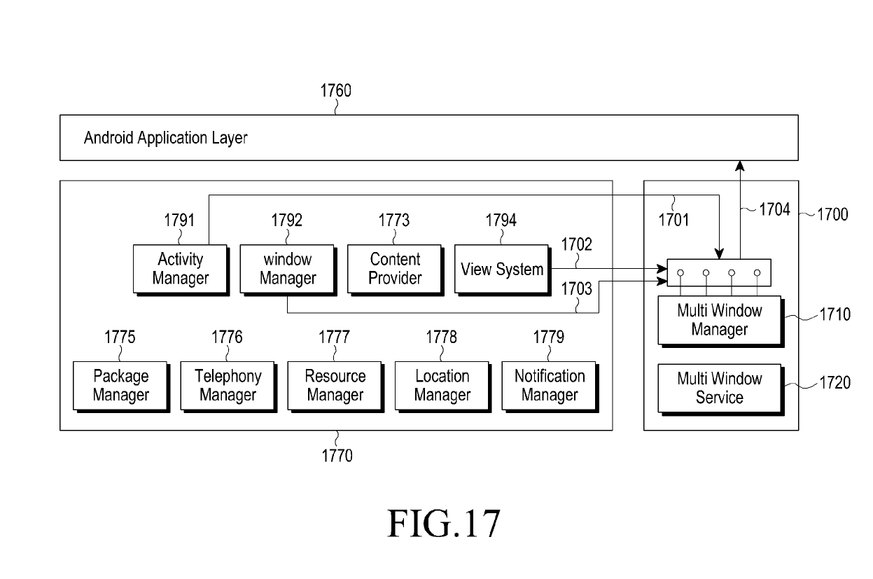

FIG. 17 is a conceptual diagram illustrating middleware or framework according to the present disclosure.

As illustrated in FIG. 17, in a framework 1770, an activity manager 1791, a window manager 1792, and a view system 1794 may be compatible with a multi window framework 1700.

The multi window framework 1700 includes a multi window manager 1710 and a multi window service 1720.

The activity manager 1791, the window manager 1792, and the view system 1794 may perform a function of calling an API for multiple windows.

The multi window manager 1710 provides a function of the multi window service 1720 in an API form to a user, and a Manager/Service structure may operate based on IPC.

The multi window service 1720 traces lifecycles of applications executed in multiple windows, and may manage statuses of the applications, such as a size, a location or the like.

The called API may manage a size, a location, and visibility of each window.

As described above, the framework according to the present disclosure may be implemented in a manner of providing an independent multi window framework and then calling an API.

The Multi window manager 1710 may call API 1701, 1702 and 1703 from each of the activity manager 1791, view system 1794 and window manager 1792.

Also, an application layer 1760 may directly call the API 1704 from the multi window manager 1710. That is, a user may use the API by receiving the API from the multi window manager 1710 even when a new application is developed.

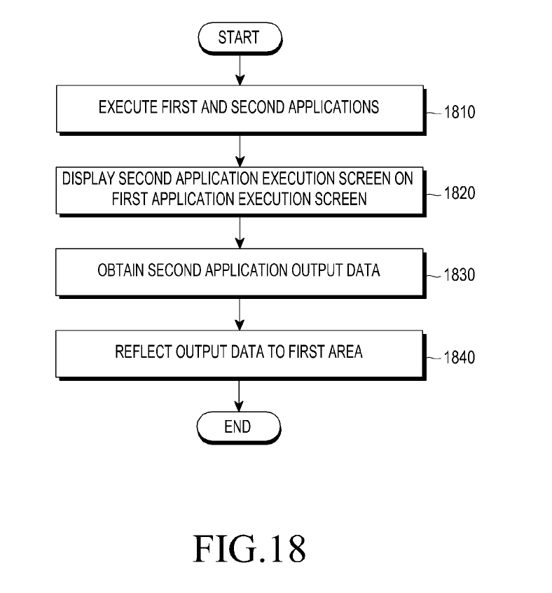

FIG. 18 is a flowchart illustrating a method of processing data according to various embodiments of the present disclosure.

In operation 1810, the electronic device 101 executes a first application and a second application.

In operation 1820, the electronic device 101 displays a second application execution screen in a first area of a first application execution screen. That is, the electronic device 101 may not display the first application execution screen but may display the second application execution screen, in a portion where the first application execution screen and the second application execution screen overlap.

In operation 1830, the electronic device 101 obtains output data from the second application.

In operation 1840, the electronic device 101 may reflect obtained output data to the first area of the first application execution screen. Here, reflecting the output data corresponds to displaying a corresponding image or video in the first area when the output data is an image or a video. Alternatively, reflecting the output data may correspond to displaying a hyperlink that provides a connection to a corresponding URL, in the first area when the output data is a URL. That is, reflecting the output data may correspond to displaying the output data as it is, or displaying data obtained by processing again the output data.

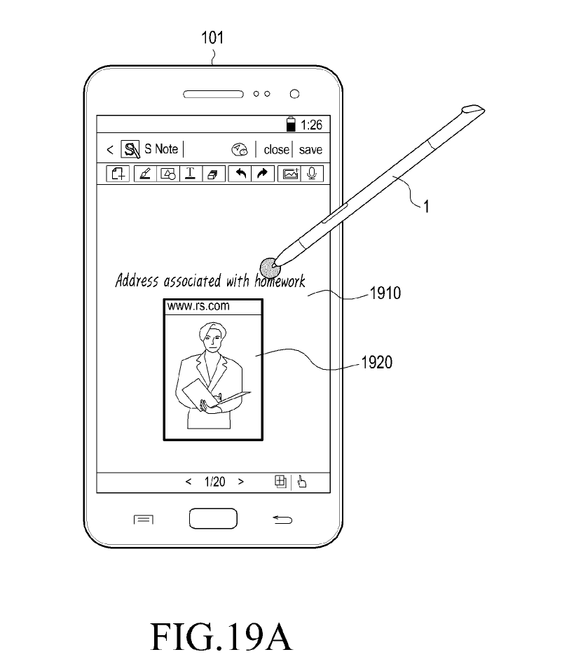

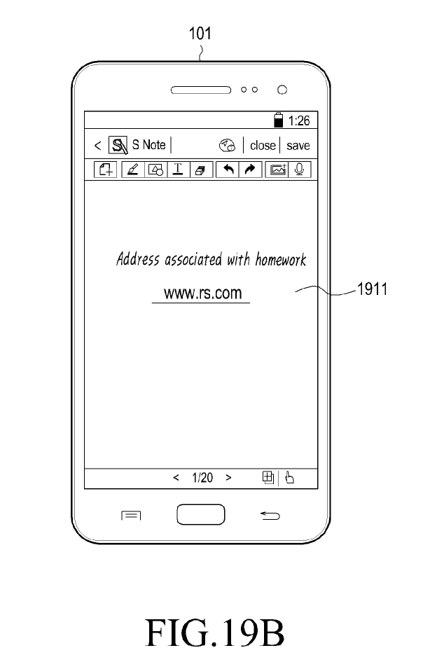

FIGS. 19A and 19B illustrate screen configurations of an electronic device according to various embodiments of the present disclosure.

As illustrated in FIG. 19A, the electronic device 101 may display a second application execution screen 1920 on a first application execution screen 1910. In the embodiment of FIG. 19A, a first application is a memo application and a second application is a web browsing application.

In FIG. 19A, a user may input a reflection command to reflect output data from the second application to the first application execution screen 1910. The electronic device 101 may reflect the output data from the second application to a first application execution screen 1911, based on the obtained reflection command, as shown in FIG. 19B. In FIG. 19A, the output data from the second application may be an image including a URL and a related object. The electronic device 101 may recognize a property of an application, and converts the output data into representative data which represents the corresponding property. The electronic device 101 may reflect the URL which is the representative data, to the first application execution screen 1911. Here, a hyperlink in a form of text, as opposed to an image, may be reflected to the first application execution screen 1911, as representative data. In another embodiment of the present disclosure, the electronic device 101 may reflect the entire web browsing screen 1920 to the first application execution screen.

Those skilled in the art may readily recognize that types of a first application and a second application are not limited, and a type and property of data output from the second application are also not limited.

According to various embodiments of the present disclosure, a screen configuring method may include displaying a first application execution screen, obtaining a first area of the first application execution screen, displaying a camera application execution screen in the first area, obtaining an image displayed on the camera application execution screen, and reflecting the obtained image to the first application.

According to various embodiments of the present disclosure, the operation of reflecting the obtained image may include displaying the obtained image on the first area of the first application execution screen.

According to various embodiments of the present disclosure, the operation of displaying the camera application execution screen includes displaying a preview screen that displays an obtained image in real time, and a photographing command icon.

According to various embodiments of the present disclosure, the operation of obtaining the image includes obtaining and storing an image that is displayed on the preview screen in response to selection of the photographing command icon.

According to various embodiments of the present disclosure, the screen configuring method further includes editing the camera application execution screen.

According to various embodiments of the present disclosure, the operation of editing the camera application execution screen includes obtaining a location change command to change a display location of the camera application execution screen, and displaying the camera application execution screen by changing the display location based on the obtained location change command.

According to various embodiments of the present disclosure, the operation of editing the camera application execution screen includes obtaining an editing command to change a size of the camera application execution screen.

According to various embodiments of the present disclosure, the operation of editing the camera application execution screen further includes displaying the camera application execution screen by changing the size of the camera application execution screen or a size of an object displayed in the camera application execution screen, based on the editing command.

According to various embodiments of the present disclosure, the operation of editing the camera application execution screen includes obtaining a crop command to crop a first area of an obtained entire image, and displaying the first area on the camera application execution screen, based on the crop command.

According to various embodiments of the present disclosure, the screen configuring method further includes adjusting the size of the camera application execution screen, based on a size of the first area.

According to various embodiments of the present disclosure, an electronic device includes a display to display a first application execution screen, and a processor to execute a control to obtain a first area of the first application execution screen, to display a camera application execution screen in the first area, to execute a control to obtain an image displayed on the camera application execution screen, and to reflect the obtained image to a first application. According to various embodiments of the present disclosure, the processor executes a control to display the obtained image on the first area of the first application execution screen.

According to various embodiments of the present disclosure, the processor executes a control to display a preview screen that displays an obtained image in real time, and a photographing command icon.

According to various embodiments of the present disclosure, the processor executes a control to obtain and store an image that is displayed on the preview screen, in response to selection of the photographing command icon.

According to various embodiments of the present disclosure, the processor edits the camera application execution screen.

According to various embodiments of the present disclosure, the processor executes a control to obtain a location change command to change a display location of the camera application execution screen, and to display the camera application execution screen by changing the display location based on the obtained location change command.

According to various embodiments of the present disclosure, the processor obtains an editing command to change a size of the camera application execution screen.

According to various embodiments of the present disclosure, the processor executes a control to display the camera application execution screen by changing a size of the camera application execution screen or a size of an object displayed in the camera application execution screen.

According to various embodiments of the present disclosure, the processor executes a control to obtain a crop command to crop a first area of an obtained entire image, and to display the first area on the camera application execution screen, based on the crop command.

According to various embodiments of the present disclosure, the processor executes a control to display the camera application execution screen by adjusting the size of the camera application execution screen based on the size of the first area.

According to various embodiments of the present disclosure, a screen configuring method of an electronic device includes generating a first surface associated with a first application, generating a second surface associated with a second application, flinging the first surface and the second surface, and execute an outputting function, generating a third surface by reflecting data of the second application to the first surface, and outputting the third surface.

According to various embodiments of the present disclosure, the operation of generating the third surface includes obtaining a location of a first area of the second surface, and generating the third surface by reflecting the data to a location of the first surface, which corresponds to the first area.

According to various embodiments of the present disclosure, a screen configuring method includes displaying a first application execution screen, displaying a second application execution screen on a first area of the first application execution screen, obtaining data from the second application and location information of the first area, and reflecting the data to the first application execution screen, based on the location information of the first area.

According to various embodiments of the present disclosure, an electronic device includes a display to display a first application execution screen and to display a second application execution screen in a first area of the first application execution screen, and a processor to obtain data from the second application and location information of the first area, and t reflect the data to the first application execution screen, based on the location of the first area.

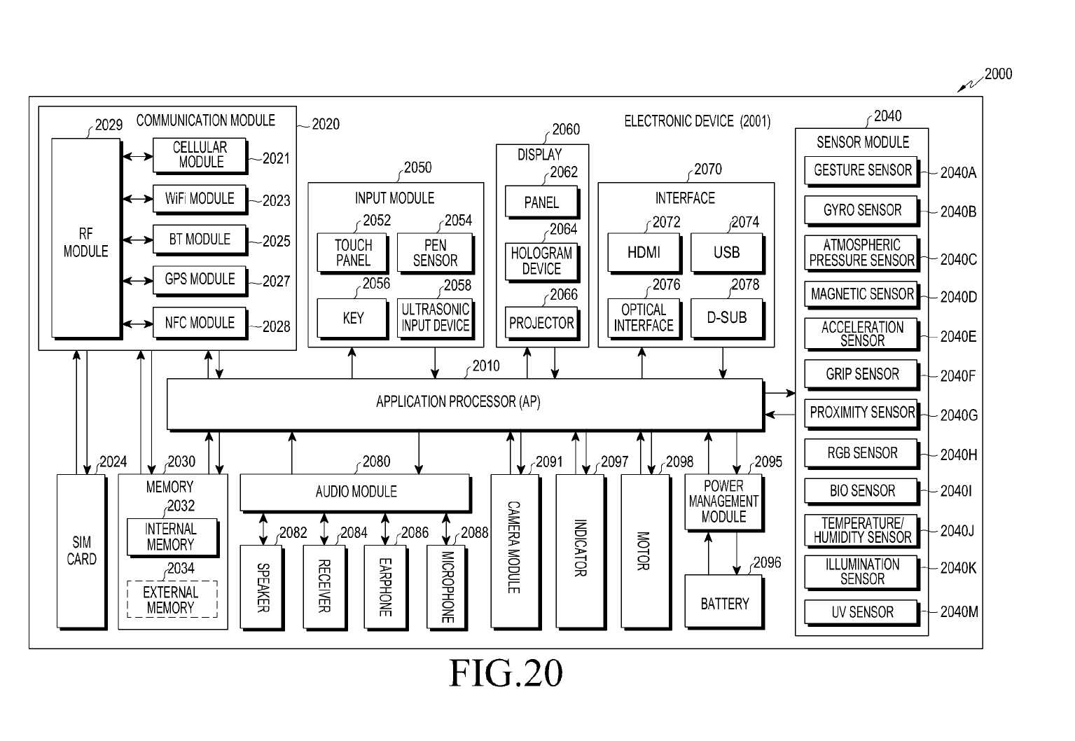

FIG. 20 is a block diagram 2000 of an electronic device 2001 according to various embodiments of the present disclosure. The electronic device 2001 may include, for example, all or some of the electronic device 101 of FIG. 1. The electronic device 2001 may include at least one Application Processor (AP) 2010, a communication module 2020, a Subscriber Identification Module (SIM) card 2024, a memory 2030, a sensor module 2040, an input module 2050, a display 2060, an interface 2070, an audio module 2080, a camera module 2091, a power management module 2095, a battery 2096, an indicator 2097, and a motor 2098.

The AP 2010 may control a plurality of hardware or software components connected thereto by driving an operating system or an application program and performing a variety of data processing and calculations. The AP 2010 may be embodied as, for example, a System on Chip (SoC). According to an embodiment of the present disclosure, the AP 2010 may further include a Graphic Processing Unit (GPU) and/or an image signal processor. The AP 2010 may include, for example, a cellular module. The AP 2010 may load instructions or data received from at least one other components (e.g., a non-volatile memory) in a volatile memory to process the loaded instructions or data, and, may store various data in a non-volatile memory.

The communication module 2020 may have a configuration equal or similar to the communication interface 170 of FIG. 1. The communication module 2020 may include, for example, a cellular module 2021, a Wi-Fi module 2023, a BT module 2025, a GPS module 2027, an NFC module 2028, and a Radio Frequency (RF) module 2029.

The cellular module 2021 may provide a voice call, image call, a text message service, Internet service, or the like through, for example, a communication network. According to an embodiment of the present disclosure, the cellular module 2021 may identify and authenticate the electronic device 2001 in a communication network using a subscriber identification module (e.g., the SIM card 2024). According to an embodiment of the present disclosure, the cellular module 2021 may perform at least some of functions that the AP 2010 may provide. According to an embodiment of the present disclosure, the cellular module 2021 may include a Communication Processor (CP).

Each of the Wi-Fi module 2023, the BT module 2025, the GPS module 2027, and the NFC module 2028 may include, for example, a processor for processing data transmitted/received through a corresponding module. According to an embodiment of the present disclosure, at least some (two or more) of the cellular module 2021, the Wi-Fi module 2023, the BT module 2025, the GPS module 2027, and the NFC module 2028 may be included in one Integrated Chip (IC) or IC package.

The RF module 2029 may transmit/receive, for example, a communication signal (e.g., an RF signal). The RF module 2029 may include, for example, a transceiver, a Power Amp Module (PAM), a frequency filter, a Low Noise Amplifier (LNA), or an antenna. According to another embodiment of the present disclosure, at least one of the cellular module 2021, the Wi-Fi module 2023, the BT module 2025, the GPS module 2027, and the NFC module 2028 may transmit/receive an RF signal through a separate RF module.

The SIM card 2024 may include, for example, a card including a subscriber identification module and/or an embedded SIM, and may further include unique identification information (e.g., an Integrated Circuit Card Identifier (ICCID)) or subscriber information (e.g., International Mobile Subscriber Identity (IMSI)).

The memory 2030 (e.g., the memory 130) may include, for example, an embedded memory 2032 or an external memory 2034. The embedded memory 2032 may include at least one of a volatile memory (e.g., a Dynamic Random Access Memory (DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard drive, a Solid State Drive (SSD), and the like).

The external memory 2034 may further include a flash drive, for example, a Compact Flash (CF), a Secure Digital (SD), a Micro Secure Digital (Micro-SD), a Mini Secure Digital (Mini-SD), an extreme Digital (xD), a memory stick or the like. The external memory 2034 may be functionally and/or physically connected to the electronic device 2001 through various interfaces.

The sensor module 2040 may measure, for example, a physical quantity or detect an operation state of the electronic device 2001, and may convert the measured or detected information to an electrical signal. The sensor module 2040 may include, for example, at least one of a gesture sensor 2040A, a gyro sensor 2040B, an atmospheric pressure sensor 2040C, a magnetic sensor 2040D, an acceleration sensor 2040E, a grip sensor 2040F, a proximity sensor 2040G, a color sensor 2040H (e.g., red, green, and blue (RGB) sensor), a biometric sensor 2040I, a temperature/humidity sensor 2040J, an illumination sensor 2040K, and an Ultra Violet (UV) sensor 2040M. Additionally or alternatively, the sensor module 2040 may include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 2040 may further include a control circuit for controlling at least one sensor included therein. In an embodiment of the present disclosure, the electronic device 2001 may further include a processor configured to control the sensor module 2040 as a part of or separately from the AP 2010, and may control the sensor module 2040 while the AP 2010 is in a sleep mode.

The input module 2050 may include, for example, a touch panel 2052, a (digital) pen sensor 2054, a key 2056, or an ultrasonic input device 2058. The touch panel 2052 may use at least one of, for example, a capacitive type, a resistive type, an infrared type, and an ultrasonic type. Also, the touch panel 2052 may further include a control circuit. The touch panel 2052 may further include a tactile layer and provide a tactile reaction to the user.

The (digital) pen sensor 2054 may include, for example, a recognition sheet which is a part of the touch panel or a separate recognition sheet. The key 2056 may include, for example, a physical button, an optical key or a keypad. The ultrasonic input unit 2058 may identify data by detecting a sound wave with a microphone (e.g., a microphone 2088) of the electronic device 2001, through an input unit for generating an ultrasonic signal. The display 2060 (e.g., the display 160) may include a panel 2062, a hologram device 2064 or a projector 2066. The panel 2062 may include a configuration equal or similar to the display 160 of FIG. 1. The panel 2062 may be embodied to be, for example, flexible, transparent, or wearable. The panel 2062 may also be integrated with the touch panel 2052 as a single module. The hologram device 2064 may show a stereoscopic image in the air by using interference of light. The projector 2066 may project light onto a screen to display an image. For example, the screen may be located inside or outside the electronic device 2001. According to an embodiment of the present disclosure, the display 2060 may further include a control circuit for controlling the panel 2062, the hologram device 2064, or the projector 2066.

The interface 2070 may include, for example, a High-Definition Multimedia Interface (HDMI) 2072, a Universal Serial Bus (USB) 2074, an optical interface 2076, or a D-subminiature (D-sub) 2078. The interface 2070 may be included in, for example, the communication interface 170 illustrated in FIG. 1. Additionally or alternatively, the interface 2070 may include, for example, a Mobile High-definition Link (MHL) interface, a Secure Digital (SD) card/Multi-Media Card (MMC) interface, or an Infrared Data Association (IrDA) standard interface.

The audio module 2080 may bilaterally convert, for example, a sound and an electrical signal. At least some components of the audio module 2080 may be included in, for example, the input/output interface 140 illustrated in FIG. 1. The audio module 2080 may process sound information input or output through, for example, a speaker 2082, a receiver 2084, earphones 2086, the microphone 2088, or the like.

The camera module 2091 is a device which may photograph a still image and a video. According to an embodiment of the present disclosure, the camera module 2091 may include one or more image sensors (e.g., a front sensor or a back sensor), a lens, an Image Signal Processor (ISP) or a flash (e.g., LED or xenon lamp).

The power management module 2095 may manage, for example, power of the electronic device 2001. According to an embodiment of the present disclosure, the power management module 2095 may include a Power Management Integrated Circuit (PMIC), a charger Integrated Circuit (IC), or a battery or fuel gauge. The PMIC may have a wired and/or wireless charging scheme. A magnetic resonance scheme, a magnetic induction scheme, or an electromagnetic scheme may be exemplified as the wireless charging scheme, and an additional circuit for wireless charging, such as a coil loop, a resonance circuit, a rectifier, and the like may be added. The battery gauge may measure, for example, a residual quantity of the battery 2096, a charging voltage and current, or temperature. The battery 2096 may include, for example, a rechargeable battery and/or a solar battery.

The indicator 2097 may indicate particular status of the electronic device 2001 or a part thereof (e.g., the AP 2010), for example, a booting status, a message status, a charging status, or the like. The motor 2098 may convert an electrical signal into mechanical vibrations, and may generate a vibration, haptic effect, or the like. Although not illustrated, the electronic device 2001 may include a processing device (e.g., a GPU) for supporting mobile TV. The processing device for supporting mobile TV may process media data according to a standard of Digital Multimedia Broadcasting (DMB), Digital Video Broadcasting (DVB), media flow or the like.

Each of the components of the electronic device according to the present disclosure may be implemented by one or more components and the name of the corresponding component may vary depending on a type of the electronic device. In various embodiments, the electronic device may include at least one of the above-described elements. Some of the above-described elements may be omitted from the electronic device, or the electronic device may further include additional elements. Further, some of the components of the electronic device according to the various embodiments of the present disclosure may be combined to form a single entity, and thus, may equivalently execute functions of the corresponding elements prior to the combination.

The term “module” used in the present disclosure may refer to, for example, a unit including one or more combinations of hardware, software, and firmware. The “module” may be interchangeable with a term, such as a unit, a logic, a logical block, a component, or a circuit. The “module” may be the smallest unit of an integrated component or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (e.g., modules or functions thereof) or the method (e.g., operations) according to the present disclosure may be implemented by a command stored in a computer-readable storage medium in a programming module form. The command, when executed by one or more processors (e.g., the processor 120), may cause the one or more processors to perform a function corresponding to the command. The computer-readable storage medium may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

According to various embodiments of the present disclosure, a storage medium stores instructions, and the instructions are set to enable at least one processor to execute at least one operation when the instructions are executed by the at least one processor, the at least one operation including: displaying a first application execution screen; obtaining a first area of the first application execution screen; displaying a camera application execution screen in the first area; obtaining an image displayed on the camera application execution screen; and reflecting the obtained image to a first application.

Various embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

What is claimed is:

1. A method of configuring a screen, the method comprising:
displaying a first application execution screen;
obtaining a first area of the first application execution screen;
displaying a camera application execution screen in the first area;
obtaining an image displayed on the camera application execution screen; and
reflecting the obtained image to a first application.

2. The method of claim 1, wherein the reflecting of the obtained image comprises:
displaying the obtained image on the first area of the first application execution screen.

3. The method of claim 1, wherein the displaying of the camera application execution screen comprises:
displaying a preview screen that displays an obtained image in real time, and a photographing command icon.

4. The method of claim 3, wherein the obtaining of the image comprises:
obtaining and storing an image that is displayed on the preview screen in response to a selection of the photographing command icon.

5. The method of claim 1, further comprising:
editing the camera application execution screen.

6. The method of claim 5, wherein the editing of the camera application execution screen comprises:
obtaining a location change command to change a display location of the camera application execution screen; and
displaying the camera application execution screen by changing the display location based on the obtained location change command.

7. The method of claim 5, wherein the editing of the camera application execution screen comprises:
obtaining an editing command to change a size of the camera application execution screen.

8. The method of claim 7, wherein the editing of the camera application execution screen further comprises:
displaying the camera application execution screen by changing the size of the camera application execution screen or a size of an object displayed in the camera application execution screen, based on the editing command.

9. The method of claim 5, wherein the editing of the camera application execution screen comprises:
obtaining a crop command to crop a first area of an obtained entire image; and
displaying the first area on the camera application execution screen, based on the crop command.

10. The method of claim 9, further comprising:
adjusting a size of the camera application execution screen, based on a size of the first area.

11. An electronic device, comprising:
a display to display a first application execution screen; and
a processor to execute a control to obtain a first area of the first application execution screen and to display a camera application execution screen in the first area, and to execute a control to obtain an image displayed on the camera application execution screen and to reflect the obtained image to a first application.

12. The electronic device of claim 11, wherein the processor executes a control to display the obtained image on the first area of the first application execution screen.

13. The electronic device of claim 11, wherein the processor executes a control to display a preview screen that displays an obtained image in real time, and a photographing command icon.

14. The electronic device of claim 13, wherein the processor executes a control to obtain and store an image that is displayed on the preview screen, in response to selection of the photographing command icon.

15. The electronic device of claim 11, wherein the processor edits the camera application execution screen.

16. The electronic device of claim 15, wherein the processor executes a control to obtain a location change command to change a display location of the camera application execution screen, and to display the camera application execution screen by changing the display location based on the obtained location change command.

17. The electronic device of claim 15, wherein the processor obtains an editing command to change a size of the camera application execution screen.

18. The electronic device of claim 17, wherein the processor executes a control to display the camera application execution screen by changing a size of the camera application execution screen or a size of an object displayed in the camera application execution screen.

19. The electronic device of claim 15, wherein the processor executes a control to obtain a crop command to crop a first area of an obtained entire image, and to display the first area on the camera application execution screen, based on the crop command.

20. The electronic device of claim 19, wherein the processor executes a control to display the camera application execution screen by adjusting a size of the camera application execution screen based on a size of the first area.

21. A machine-readable storage medium that records a program for implementing a screen configuring method of an electronic device, and the method comprising:
displaying a first application execution screen;
obtaining a first area of the first application execution screen;
displaying a camera application execution screen in the first area;
obtaining an image displayed on the camera application execution screen; and
reflecting the obtained image to a first application.

22. A method of configuring a screen, the method comprising:
generating a first surface associated with a first application;
generating a second surface associated with a second application;
flinging the first surface and the second surface, and executing outputting;
generating a third surface by reflecting data of the second application to the first surface; and
outputting the third surface.

23. The method of claim 22, wherein the generating of the third surface comprises:
obtaining a location of a first area of the second surface; and
generating the third surface by reflecting the data to a location of the first surface, which corresponds to the first area.

24. A method of configuring a screen, the method comprising:
displaying a first application execution screen;
displaying a second application execution screen on a first area of the first application execution screen;
obtaining data from a second application and location information of the first area; and
reflecting the obtained data to the first application execution screen, based on the location information of the first area.

25. An electronic device, comprising:
a display to display a first application execution screen, and to display a second application execution screen in a first area of the first application execution screen; and
a processor to obtain data from a second application and location information of the first area, and reflecting the data to the first application execution screen, based on a location of the first area.
